(19) United States
(12) Patent Application Publication
(10) Pub. No.: US 2023/0318455 A1
(43) Pub. Date: Oct. 5, 2023

(54) BATTERY SURGE REDUCTION USING A TRANSIENT AUXILIARY CONVERTER

(71) Applicant: TEXAS INSTRUMENTS INCORPORATED, Dallas, TX (US)

(72) Inventors: Sombuddha CHAKRABORTY, Redwood City, CA (US); Kevin SCOONES, San Jose, CA (US); Pourya ASSEM, Sunnyvale, CA (US)

(21) Appl. No.: 17/708,849

(22) Filed: Mar. 30, 2022

(51) Int. Cl. H02M 3/158; H02M 1/08; H02M 1/14; H02H 9/00

(52) U.S. Cl. CPC H02M 3/158; H02M 1/08; H02M 1/14; H02H 9/005

(57) ABSTRACT

A transient auxiliary converter includes: a transient auxiliary converter terminal; an inductor having a first side and a second side, the first side of the inductor coupled to the transient auxiliary converter terminal; a capacitor having a first electrode and a second electrode, the second electrode of the capacitor being coupled to ground; a first switch between the second side of the inductor and the first electrode of the capacitor; and a second switch between the second side of the inductor and ground. The first and second switches are operated in accordance with a charge mode and a transient response mode for the transient auxiliary converter. The charge mode builds up charge on the capacitor from charge at the transient auxiliary converter terminal. The transient response mode releases charge on the capacitor to the transient auxiliary converter terminal.

### BACKGROUND

As new electronic devices are developed and integrated circuit (IC) technology advances, new IC products are commercialized. One example IC product is a switching converter, which provides an output voltage based on an input voltage. Switching converters include a controller and a power stage, and are used in various electronic devices to regulate power to one or more loads.

Battery surge due to sudden load demand is a common problem for electronic devices (e.g., smartphones) running off a single or dual battery. A conventional approach to mitigate the problem is to add costly multi-layer ceramic capacitors (MLCCs) at the power stage input and/or the power stage output to offset the current demand from the battery.

### SUMMARY

In one example embodiment, a transient auxiliary converter includes: a transient auxiliary converter terminal; an inductor having a first side and a second side, the first side of the inductor coupled to the transient auxiliary converter terminal; a capacitor having a first electrode and a second electrode, the second electrode of the capacitor being coupled to ground; a first switch between the second side of the inductor and the first electrode of the capacitor; and a second switch between the second side of the inductor and ground. The first switch and the second switch are operated in accordance with a charge mode and a transient response mode for the transient auxiliary converter. The charge mode builds up charge on the capacitor from charge at the transient auxiliary converter terminal. The transient response mode releases charge on the capacitor to the transient auxiliary converter terminal.

In another example embodiment, a system comprises a power stage having a power stage input, a power stage output and switches, the power stage input configured to receive an input voltage, and the power stage configured to provide an output volage at the power stage output responsive to the input voltage and operation of the switches. The system includes a power stage controller coupled to control terminals of the switches and configured to provide control signals to the control terminals to maintain the output voltage at a target output voltage. The system also includes a transient auxiliary converter having a transient auxiliary converter terminal coupled to the power stage output. The transient auxiliary converter is configured to: store charge from the power stage output during a steady-state load condition; and release the stored charge to the power stage output during a transient load condition after the steady-state load condition

In yet another example embodiment, a method is performed by a transient auxiliary converter coupled to a power stage output. The method includes: monitoring a load condition at the power stage output; responsive to a steady-state load condition, storing charge from the power stage output to a capacitor of the transient auxiliary converter; and responsive to a transient load condition, releasing the stored charge on the capacitor to the power stage output.

### BRIEF DESCRIPTION OF THE DRAWINGS

FIG. 1 is a block diagram of a system having a transient auxiliary converter in accordance with an example embodiment.

FIG. 2 is a block diagram of another system having a transient auxiliary converter in accordance with an example embodiment.

FIGS. 3-6 are graphs of system signals as a function of time in accordance with example embodiments.

FIGS. 7A-7C are graphs of load profiles as a function of time in accordance with example embodiments.

FIG. 8 is a graph of system signals as a function of time in accordance with an example embodiment.

FIG. 9A is a diagram of an equivalent circuit in accordance with an example embodiment.

FIGS. 9B and 10 are graphs of system signals showing output voltage ripple cancellation using a transient auxiliary converter in accordance with an example embodiment.

FIG. 11 is a flowchart of a transient auxiliary converter method in accordance with an example embodiment.

### DETAILED DESCRIPTION

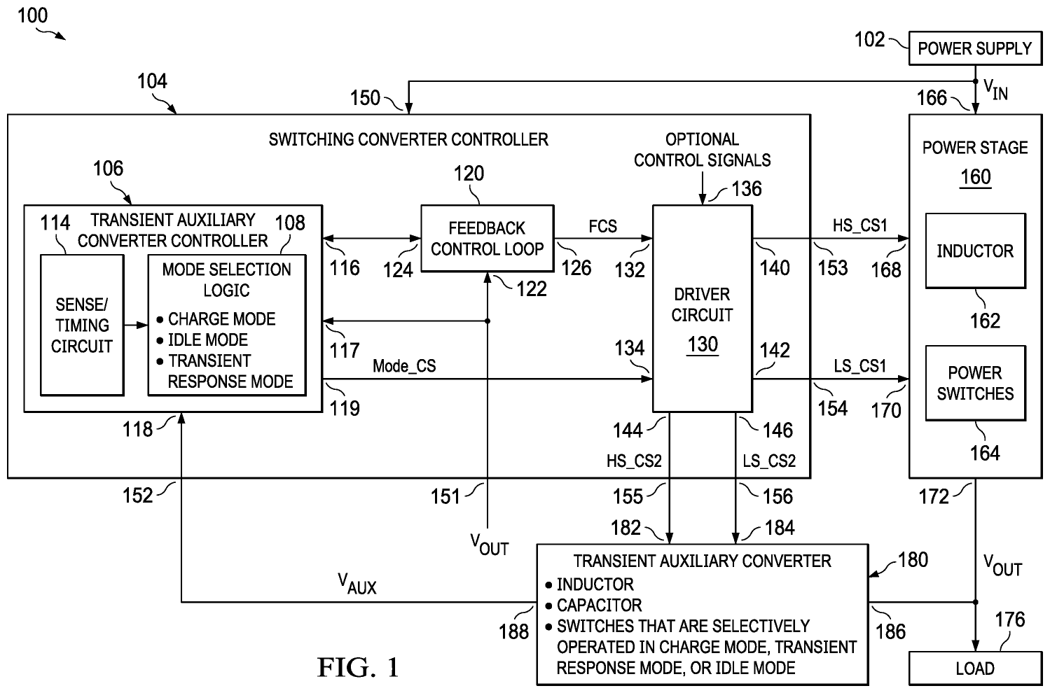

The same reference numbers (or other reference designators) are used in the drawings to designate the same or similar (structurally and/or functionally) features. FIG. 1 is a block diagram of a system 100 in accordance with an example embodiment. The system 100 represents any electrical device with a load 176, a power supply 102 (e.g., a battery or other direct-current (DC) power source), and power management circuitry including a power stage 160 and a switching converter controller 104. As shown, the power stage 160 includes: a power stage input 166; a first drive signal input 168; a second drive signal input 170; a power stage output 172; an inductor 162; and power switches 164. The power switches 164 have respective control terminals coupled to the first drive signal input 168 and the second drive signal input 170.

In different example embodiments, the topology (e.g., the arrangement of the inductor 162 and the power switches 164) of the power stage 160 may vary. Example topologies for the power stage 160 include a boost converter topology, a buck converter topology, or a buck-boost converter topology. In a buck converter topology, V_{OUT} at the power stage output 172 is less than the input voltage (V_{IN}) provided to the power stage input 166 by the power supply 102. In a boost converter topology, V_{OUT} is greater than V_{IN}. In a buck-boost converter topology, V_{OUT} may be greater than or less than V_{IN}. In some example embodiments, the power stage 160 includes multiple inductors and multiple sets of power switches (e.g., a multi-phase power stage). In such embodiments, the power stage 160 includes additional inputs for the control signals for any additional power switches and the switching converter controller 104 includes additional outputs to provide the control signals.

As shown, the switching converter controller 104 includes a first switching converter controller input 150, a second switching converter controller input 151, a third switching converter controller input 152, a first switching converter controller output 153, a second switching converter controller output 154, a third switching converter controller output 155, and a fourth switching converter controller output 156. The first switching converter controller input 150 is configured to receive V_{IN} from the power stage 102. The second switching converter controller input 151 is configured to receive V_{OUT} from the power stage output 172. In the example of FIG. 1, the third switching converter controller input 152 is configured to receive an auxiliary voltage (V_{AUX}) from a transient auxiliary converter output 188 of a transient auxiliary converter 180 coupled to the power stage output 172.

In operation, the switching converter controller 104 is configured to operate the power switches 164 of the power stage 160 to regulate power to the load 176 based on a feedback control loop 120. In some example embodiments, the feedback control loop 120 is configured to compare V_{OUT} at the power stage output 172 (or a scaled version of V_{OUT}) to a reference voltage. As appropriate, the switching frequency of the power switches 164 is increased or decreased responsive to a demand of the load 176, which may vary over time. In the example of FIG. 1, the feedback control loop 120 includes a feedback control loop input 122 and a feedback control loop output 126. The feedback control loop input 122 is coupled to the second switching converter controller input 151 and is configured to receive V_{OUT}. The feedback control loop output 126 is coupled to a driver circuit input 132 of a driver circuit 130. In operation, the feedback control loop 120 is configured to provide a feedback control signal (FCS) at the feedback control loop output 126 responsive to an error between V_{OUT} and the reference voltage. In some example embodiments, FCS is also a function of a feedforward signal (to track fast changes in V_{OUT} and/or V_{IN}) and/or other control options. In some example embodiments, the driver circuit 130 includes other driver circuit inputs 136 configured to receive other control signals. Without limitation, the other control signals are based on pulse frequency modulation (PFM) control, pulse-width modulation (PWM) control, multi-phase control, zero crossing detection, and/or other control options.

Besides the driver circuit input 132 and the other driver circuit inputs 136, the driver circuit 130 includes a first driver circuit output 140 and a second driver circuit output 142. In operation, the driver circuit 130 is configured to provide power switch drive signals for the power switches 164 responsive to FCS received at the driver circuit input 132 and/or the other control signals received at the driver circuit inputs 136. More specifically, the driver circuit 130 is configured to provide a high-side power switch drive signal (HS_CS1) to the first driver circuit output 140 and a low-side power switch drive signal (LS_CS1) to the second driver circuit output 142 responsive to FCS received at the driver circuit input 132 and/or the other control signals received at the driver circuit inputs 136.

In some example embodiments, the switching converter controller 104 is an integrated circuit (IC) that includes the feedback control loop 120, the driver circuit 130, related inputs/outputs, and/or other components related to controlling the operations of the power stage 160 to regulate power to the load 176. In addition, the switching converter controller 104 of FIG. 1 includes a transient auxiliary converter controller 106 configured to control switches of the transient auxiliary converter 180. In other example embodiments, the transient auxiliary converter controller 106 is a separate circuit or IC relative to the switching converter controller 104. With separate ICs, load scalability is improved.

As shown, the transient auxiliary converter 180 includes a first drive signal input 182, a second drive signal input 184, a transient auxiliary converter terminal 186, and the transient auxiliary converter output 188. The first drive signal input 182 of the transient auxiliary converter 180 is coupled to the third drive signal output 155 of the switching converter controller 104. The second drive signal input 184 of the transient auxiliary converter 180 is coupled to the fourth drive signal output 156 of the switching converter controller 104.

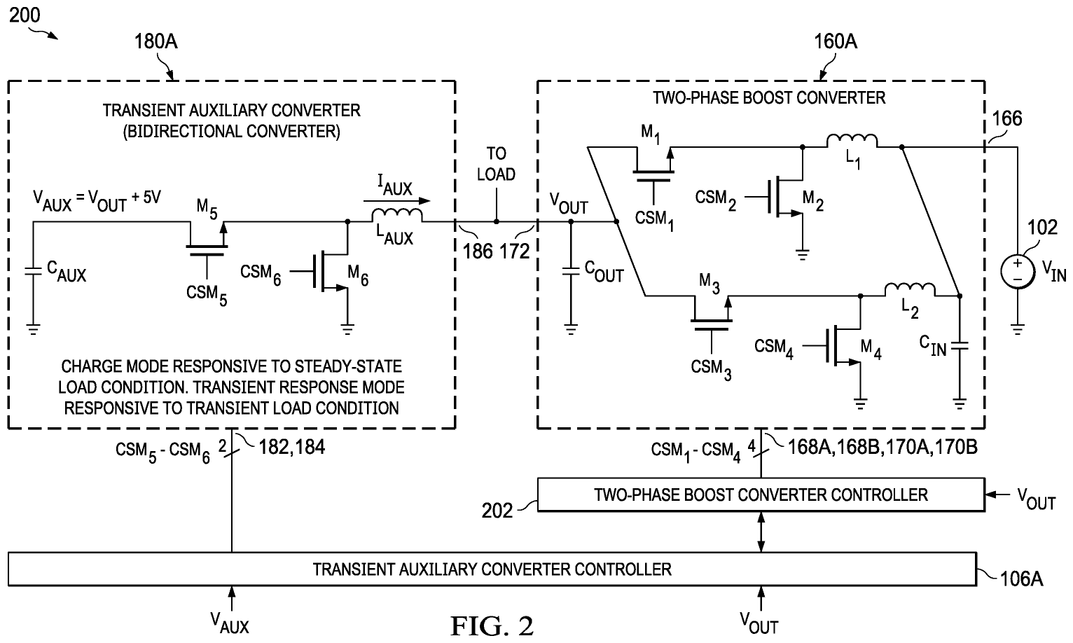

In some example embodiments, the transient auxiliary converter 180 includes an inductor (e.g., L_{AUX} in FIG. 2), a capacitor (e.g., C_{AUX} in FIG. 2), and switches (e.g., M₅ and M₆ in FIG. 2), where the switches are selectively operated in a charge mode, a transient response mode, or an idle mode. In the charge mode, the switches of the transient auxiliary converter 180 are operated to build up charge on the capacitor of the transient auxiliary converter 180 from charge at the transient auxiliary converter terminal 186. In the transient response mode, the switches of the transient auxiliary converter 180 are operated to release charge on the capacitor of the transient auxiliary converter 180 to the transient auxiliary converter terminal 186. In the idle mode, the switches are idle, which maintains the charge on the capacitor of the transient auxiliary converter 180. As needed, the transient auxiliary converter 180 alternates between the charge mode and the idle mode as needed to account for losses over time. Transitions between the charge mode and the idle mode may be based on a sense signal (e.g., the charge stored by the capacitor of the transient auxiliary converter 180) and/or a time reference (e.g., a time interval indicating an amount of charge on the capacitor of the transient auxiliary converter 180, or a time interval indicating an amount of discharge from the capacitor of the transient auxiliary converter 180). As another, option, the transient auxiliary converter 180 alternates between the charge mode and the transient response mode to provide active buffering (e.g., V_{OUT} ripple cancellation) at a power stage output (e.g., the power stage output 172 in FIG. 1).

In some example embodiments, the modes of the transient auxiliary converter 180 are selected responsive to a load signal (e.g., V_{OUT} at the power stage output 172, V_{OUT} analysis results, or another load transient indicator) indicating a load condition. Responsive to a steady-state load condition (e.g., indicated by the load signal), the charge mode is used to build up charge on the capacitor of the transient auxiliary converter 180 up to a target auxiliary voltage (e.g., V_{OUT} plus a surplus voltage). Once the target auxiliary voltage is reached, the idle mode may be used to maintain the target auxiliary voltage on the capacitor of the transient auxiliary converter 180. As needed, the transient auxiliary converter 180 transitions from the idle mode to the charge mode responsive to a sense signal indicating the charge on the capacitor of transient auxiliary converter 180 has dropped below a threshold (e.g., 5% below the target auxiliary voltage). Responsive to a transient load condition (e.g., the load demand increasing suddenly as indicated by the load signal), the transient response mode is used to release charge on the capacitor of the transient auxiliary converter 180 to the transient auxiliary converter terminal 186. With the transient auxiliary converter 180 and related modes, battery surge during a load transient is reduced. As another option, the transient auxiliary converter 180 performs active buffering (e.g., V_{OUT} ripple cancellation) at a power stage output (e.g., the power stage output 172 in FIG. 1).

In some example embodiments, the transient auxiliary converter controller 106 is configured to control the modes of the transient auxiliary converter 180. In the example of FIG. 1, the transient auxiliary converter controller 106 includes a transient auxiliary converter controller terminal 116, a first transient auxiliary converter controller input 117, a second transient auxiliary converter controller input 118, and a transient auxiliary converter controller output 119. The transient auxiliary converter controller terminal 116 is coupled to a feedback control loop terminal 124 of the feedback control loop 120. In some example embodiments, the feedback control loop terminal 124 is configured to provide a load signal at the feedback control loop terminal 124 responsive to changes in V_{OUT}, a comparison of V_{OUT} with a reference voltage, or other load transient sensing techniques. In other example embodiments, the feedback control loop terminal 124 and the transient auxiliary converter controller terminal 116 are optional.

In some example embodiments, the first transient auxiliary converter controller input 117 is coupled to the second switching converter controller input 151 and is configured to receive V_{OUT}. In some example embodiments, the first transient auxiliary converter controller input 117 and the second switching converter controller input 151 are optional (e.g., if the feedback control loop 120 is configured to provide the load signal to the transient auxiliary converter controller 106). The second transient auxiliary converter controller input 118 is coupled to the third switching converter controller input 152 and is configured to receive V_{AUX} from the transient auxiliary converter terminal 188 of the transient auxiliary converter 180. The transient auxiliary converter controller output 119 is coupled to another driver circuit input 134 of the driver circuit 130. In operation, the transient auxiliary converter controller 106 is configured to provide a mode control signal (“Mode_CS”) or related control signals responsive to a load signal (e.g., from the feedback control loop 120), V_{OUT} (e.g., from the power stage output 172), and/or V_{AUX} (e.g., from the transient auxiliary converter 180).

In some example embodiments, the transient auxiliary converter controller 106 includes mode selection logic 108 configured to select between the charge mode, the idle mode, and the transient response mode responsive to a load condition (e.g., indicated by the load signal from the feedback control loop 120, analysis of V_{OUT}, or another load condition detection option), and V_{AUX}. As another option, a timing reference may be used to switch between the idle mode and the charge mode. In some example embodiments, the transient auxiliary converter controller 106 includes a sense/timing circuit 114 configured to provide control signals to the mode selection logic 108 based on a comparison of V_{OUT} with one or more threshold, comparison of V_{AUX} with one or more thresholds, and/or comparison of a timing reference with one or more thresholds. To perform such comparisons, the sense/timing circuit 114 may include comparators and related reference circuitry.

As previously mentioned, the other driver circuit input 134 of the driver circuit 130 is coupled to the transient auxiliary converter controller output 119 and is configured to receive Mode_CS or related control signals. Responsive to Mode_CS or related control signals at the transient auxiliary converter controller output 119, the driver circuit 130 is configured to provide switch drive signals to operate the switches of the transient auxiliary converter 180 in the different modes. In some example embodiments, the driver circuit 130 includes a first auxiliary drive signal output 144 and a second auxiliary drive signal output 146. The first auxiliary drive signal output 144 is configured to provide a high-side switch drive signal (HS_CS2) and the second auxiliary drive signal output 146 is configure to provide a low-side switch drive signal (LS_CS2). As shown, the first auxiliary drive signal output 144 is coupled to the third switching converter controller output 155. The second auxiliary drive signal output 146 is coupled to the fourth switching converter controller output 156. By selecting the appropriate mode and respective control signals responsive to a load condition, V_{AUX}, and/or a timing reference, the transient auxiliary converter 180 is able to reduce battery surge (a sudden change in battery current or battery voltage). As another option, the modes are selected to perform active buffering (V_{OUT} ripple cancellation) at the power stage output 172.

In some example embodiments, the timing of the switch drive control signals (e.g., HS_CS2 and LS_CS2) for the transient auxiliary converter 180 is coordinated with the timing of the switch drive control signals (e.g., HS_CS1 and LS_CS1) for the power stage 160. Without limitation, such coordination may be facilitated by combining control components of the power stage 160 with control components of the transient auxiliary converter on a single IC.

FIG. 2 is a block diagram of another system 200 having a transient auxiliary converter 180A (an example of the transient auxiliary converter 180 in FIG. 1) in accordance with an example embodiment. As shown, the system 200 includes the transient auxiliary converter 180A coupled to a transient auxiliary converter controller 106A (an example of the transient auxiliary converter controller 106 in FIG. 1). The system also includes a two-phase boost converter 160A (an example of the power stage 160 in FIG. 1) coupled to a two-phase boost converter controller 202 (e.g., part of the switching converter controller 104 in FIG. 1). In the example of FIG. 2, the transient auxiliary converter controller 106A and the two-phase boost converter controller 202 are shown as separate circuits or ICs. In other example embodiments, the transient auxiliary converter controller 106A and the two-phase boost converter controller 202 are combined in a single IC. In either case, the transient auxiliary converter 180A includes the transient auxiliary converter terminal 186 coupled to the power stage output 172, where the operations of the transient auxiliary converter 180A reduce surge at the power stage input 166 (coupled to the power supply 102) during a transient load condition. In some example embodiments, the power supply 102 is a battery, and the operations of the transient auxiliary converter 180A reduce battery surge during a transient load condition. The transient auxiliary converter 180A may also perform active buffering or V_{OUT} ripple cancellation at the power stage output 172.

In the example of FIG. 2, the power stage input 166 is configured to receive V_{IN} from the power supply 102. The two-phase boost converter 160A also includes an input capacitor (C_{IN}) between the power stage input 166 and ground. A power stage output 172 of the two-phase boost converter 160A is coupled to an output capacitor (C_{OUT}) and a load (e.g., not shown in FIG. 2). More specifically, C_{OUT} is between the power stage output 172 and ground. Between the power stage input 166 and the power stage output 172 are multiple phases, each phase having a respective inductor (L₁ and L₂).

More specifically, a first side of L₁ is coupled to the power stage input 166 and a second side of L₁ is coupled to the power stage output 172 via a first high-side power switch or transistor (M₁) controlled by a first control signal (CSM₁). The second side of L₁ is coupled to ground via a first low-side power switch or transistor (M₂) controlled by a second control signal (CSM₂). A first side of L₂ is coupled to the power stage input 166 and a second side of L₂ is coupled to the power stage output 172 via a second high-side power switch or transistor (M₃) controlled by a third control signal (CSM₃). The second side of L₂ is coupled to ground via a second low-side power switch or transistor (M₄) controlled by a fourth control signal (CSM₄). By selectively providing CSM₁-CSM₄ responsive to a load condition (indicated by V_{OUT}), the two-phase boost converter controller 202 is configured to efficiently regulate power to a load at the power stage output 172. As shown, the two-phase boost converter 160A includes drive signal inputs 168A, 168A, 170A, and 170B (examples of the first drive signal input 168 and the second driver signal input 170 in FIG. 1) coupled to the two-phase boost converter controller 202 and configured to receive CSM₁-CSM₄.

In some example embodiments, the two-phase boost converter controller 202 includes a feedback control loop (e.g., the feedback control loop 120 in FIG. 1), a driver circuit (e.g., part of the driver circuit 130 in FIG. 1), and/or other components to control the switches of the two-phase boost converter 160A. In different example embodiments, the number of phases for the power stage 160A may vary. Regardless of the number of phases for the power stage 160A, a surge at the power stage input 166 may occur responsive to a transient load condition. One effect of surges due to load demand is a temporary drop in V_{IN}, which can cause power issues (e.g., brown-outs) for other circuitry sharing the power supply 102.

With the transient auxiliary converter 180A, surges at the power stage input 166 are reduced. Also, the transient auxiliary converter 180A may perform active buffering or V_{OUT} ripple cancellation at the power stage output 172. As shown, the transient auxiliary converter 180A includes an inductor (L_{AUX}), a first switch or transistor (M₅), a second switch or transistor (M₆), and a capacitor (C_{AUX}). M₅ is controlled by a fifth control signal (CSM₅), and M₆ is controlled by a sixth control signal (CSM₆). In the example of FIG. 2, CSM₅ is provided from the transient auxiliary converter controller 106A to the first drive signal input 182 of the transient auxiliary converter 180A. Also, CSM₆ is provided from the transient auxiliary converter controller 106A to the second drive signal input 184 of the transient auxiliary converter 180A.

In the example of FIG. 2, L_{AUX} has a first side and a second side. The first side of L_{AUX} is coupled to the transient auxiliary converter terminal 186. C_{AUX} has a first electrode and a second electrode. The second electrode of C_{AUX} is coupled to ground. M₅ is between the second side of L_{AUX} and the first electrode of C_{AUX}. M₆ is between the second side of L_{AUX} and ground. In operation, the transient auxiliary converter controller 106A is configured to provide CSM₅ and CSM₆ to operate M₅ and M₅ in accordance with a charge mode and a transient response mode for transient auxiliary converter 180A. The charge mode builds up charge on C_{AUX} from charge at the transient auxiliary converter terminal 186 responsive to a steady-state load condition. The transient response mode releases charge on C_{AUX} to the transient auxiliary converter terminal 186 responsive to a transient load condition.

In some example embodiments, a transient auxiliary converter (e.g., the transient auxiliary converter 180 in FIG. 1, or the transient auxiliary converter 180A in FIG. 2) includes a transient auxiliary converter terminal (e.g., the transient auxiliary converter terminal 186 in FIGS. 1 and 2) adapted to be coupled to a load (e.g., the load 176 in FIG. 1) and a power stage output (e.g., the power stage output 172 in FIGS. 1 and 2). The transient auxiliary converter also includes: an inductor (e.g., L_{AUX} in FIG. 2) having a first side and a second side, the first side of the inductor coupled to the transient auxiliary converter terminal; a capacitor (e.g., C_{AUX} in FIG. 2) having a first electrode and a second electrode, the second electrode of the capacitor being coupled to ground; a first switch (e.g., M₅ in FIG. 2) between the second side of the inductor and the first electrode of the capacitor; and a second switch (e.g., M₆ in FIG. 2) between the second side of the inductor and ground. The first switch and the second switch are operated in accordance with a charge mode and a transient response mode for transient auxiliary converter. The charge mode builds up charge on the capacitor from charge at the transient auxiliary converter terminal. The transient response mode releases charge on the capacitor to the transient auxiliary converter terminal.

In some example embodiments, the transient auxiliary converter includes a transient auxiliary converter controller (e.g., the transient auxiliary converter controller 106 in FIG. 1, or the transient auxiliary converter controller 106A in FIG. 2) having a transient auxiliary converter controller input (e.g., the first transient auxiliary converter controller input 117, or the transient auxiliary converter controller terminal 116 in FIG. 1) and a transient auxiliary converter controller output (e.g., the transient auxiliary converter controller output 119 in FIG. 1). In some example embodiments, the transient auxiliary converter controller input is configured to receive a load signal (e.g., a load signal from the feedback control loop 120 in FIG. 1, V_{OUT} from the power stage output 172, or V_{OUT} analysis results) indicating a load condition. In such embodiments, the transient auxiliary converter controller is configured to: select the charge mode responsive to the load signal indicating a steady-state load condition; select the transient response mode responsive to the load signal indicating a transient load condition; and provide a control signal at the transient auxiliary converter controller output responsive to the selected mode.

In some example embodiments, the transient auxiliary converter controller input is a first transient auxiliary converter controller input, and the transient auxiliary converter controller includes a second transient auxiliary converter controller input (e.g., the second transient auxiliary converter controller input 118 in FIG. 1) configured to receive a sense signal (e.g., V_{AUX} in FIG. 1) indicating a charge on the capacitor. In such embodiments, the transient auxiliary converter controller is configured to: select the charge mode responsive to the load signal indicating a steady-state load condition and the sense signal being less than a threshold; select an idle mode responsive to the load signal indicating a steady-state load condition and the sense signal being equal to or greater than the threshold; select the transient response mode responsive to the load signal indicating a transient load condition; and provide a control signal (e.g., Mode_CS or related control signals in FIG. 1) at the transient auxiliary converter controller output responsive to the selected mode. In some example embodiments, the threshold is a first threshold, and the transient auxiliary converter controller is configured to transition from the idle mode to the charge mode responsive to the load signal indicating a steady-state load condition and the sense signal being less than a second threshold.

In some example embodiments, the transient auxiliary converter controller is configured to: obtain a time reference; select the charge mode responsive to the load signal indicating a steady-state load condition and the time reference being less than a threshold; select an idle mode responsive to the load signal indicating a steady-state load condition and the time reference being equal to or greater than the threshold; select the transient response mode responsive to the load signal indicating a transient load condition; and provide a control signal (e.g., Mode_CS or related control signal in FIG. 1) at the transient auxiliary converter controller output responsive to the selected mode. In some example embodiments, the threshold is a first threshold, and the transient auxiliary converter controller is configured to transition from the idle mode to the charge mode responsive to the load signal indicating a steady-state load condition and the time reference being greater than a second threshold.

In some example embodiments, the transient auxiliary converter includes a driver circuit (e.g., part of the driver circuit 130 in FIG. 1) coupled to or included with the transient auxiliary converter controller. The driver circuit has a driver circuit input (e.g., the driver circuit input 134 in FIG. 1), a first driver circuit output (e.g., the first auxiliary drive signal output 144 in FIG. 1) and a second driver circuit output (e.g., the second auxiliary drive signal output 146 in FIG. 1). The driver circuit input is coupled to the transient auxiliary converter controller output. The first driver circuit output is coupled to a control terminal of the first switch (e.g., M₅ in FIG. 2) of the transient auxiliary converter. The second driver circuit output coupled to a control terminal of the second switch (e.g., M₆ in FIG. 2) of the transient auxiliary converter.

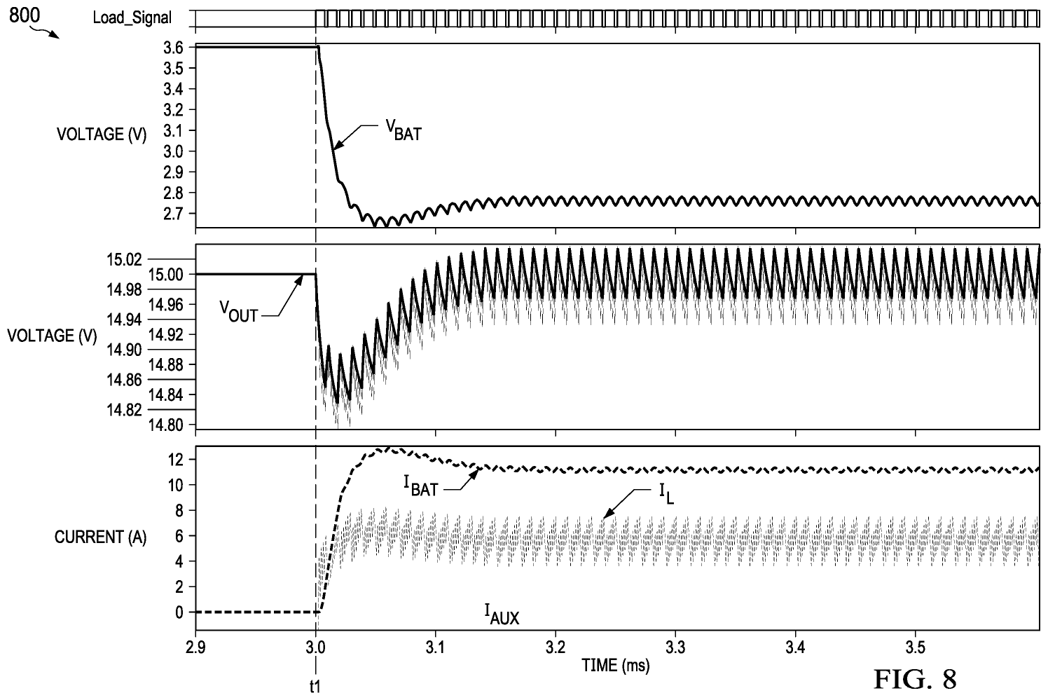

In some example embodiments, the transient auxiliary converter controller is configured to operate the first switch (e.g., M₅ in FIG. 2) and the second switch (e.g., M₆ in FIG. 2) in the charge mode to build up charge on the capacitor (e.g., C_{AUX} in FIG. 2) from charge at the transient auxiliary converter terminal responsive to the load signal indicating a steady-state load condition until the sense signal indicates a target auxiliary voltage (e.g., V_{AUX}=V_{OUT}+5V as in FIG. 2) is reached. In some example embodiments, the target auxiliary voltage is equal to a target output voltage for the load plus a surplus voltage. In some example embodiments, the surplus voltage is approximately 5 volts. In some example embodiments, the transient auxiliary converter controller is configured to operate the first switch and the second switch of the transient auxiliary converter to perform output voltage ripple cancellation (e.g., by alternating between the charge mode and the transient response mode to maintain V_{OUT} within an upper threshold and a lower threshold as in FIG. 9B) at the power stage output.

In some example embodiments, a system includes a power stage (e.g., the power stage 160 in FIG. 1, or the two-phase boost converter 160A in FIG. 2) having a power stage input (e.g., the power stage input 166 in FIGS. 1 and 2), a power stage output (e.g., the power stage output 172 in FIGS. 1 and 2) and switches (e.g., the power switches 164 in FIG. 1, or M₁ to M₄ in FIG. 2). The power stage input is configured to receive an input voltage (e.g., V_{IN} in FIGS. 1 and 2). The power stage output is adapted to be coupled to a load (e.g., the load 176 in FIG. 1). The power stage is configured to provide an output voltage (e.g., V_{OUT} in FIGS. 1 and 2) at the power stage output responsive to the input voltage and operation of the switches. The system also includes a power stage controller (e.g., part of the switching converter controller 104 in FIG. 1, or the two-phase boost converter controller 202 in FIG. 2) coupled to control terminals of the switches and configured to provide control signals (e.g., CSM₁ to CSM₄ in FIG. 2) to the control terminals to maintain the output voltage at a target output voltage. The system also includes a transient auxiliary converter (e.g., the transient auxiliary converter 180 in FIG. 1, or the transient auxiliary converter 180A in FIG. 2) having a transient auxiliary converter terminal (e.g., the transient auxiliary converter terminal 186 in FIGS. 1 and 2) coupled to the power stage output. The transient auxiliary converter is configured to: store charge from the power stage output during a steady-state load condition; and release the stored charge to the power stage output responsive to a transient load condition after the steady-state load condition.

In some example embodiments, the system also includes a transient auxiliary converter controller (e.g., the transient auxiliary converter controller 106 in FIG. 1, or the transient auxiliary converter controller 106A in FIG. 2) configured to control the first switch and the second switch to build up the charge on the capacitor during the steady-state load condition up to a target auxiliary voltage (e.g., V_{AUX}=V_{OUT}+5V), the target auxiliary voltage equal to a target output voltage for the load plus a surplus voltage. In some example embodiments, the system includes a transient auxiliary converter controller configured to retain voltage on the capacitor responsive to detecting that the charge on the capacitor reaches a threshold. In some example embodiments, the system includes a transient auxiliary converter controller configured to alternate between a charge mode and an idle mode during the steady-state load condition responsive to a sense signal that indicates a voltage on the capacitor. In some example embodiments, the system includes a transient auxiliary converter controller configured to alternate between a charge mode and an idle mode during the steady-state load condition responsive to a timing reference. In some example embodiments, the system includes a transient auxiliary converter controller configured to operate the first switch and the second switch to perform output voltage ripple cancellation at the power stage output. In some example embodiments, the transient auxiliary converter controller and the power stage controller are part on a single integrated circuit.

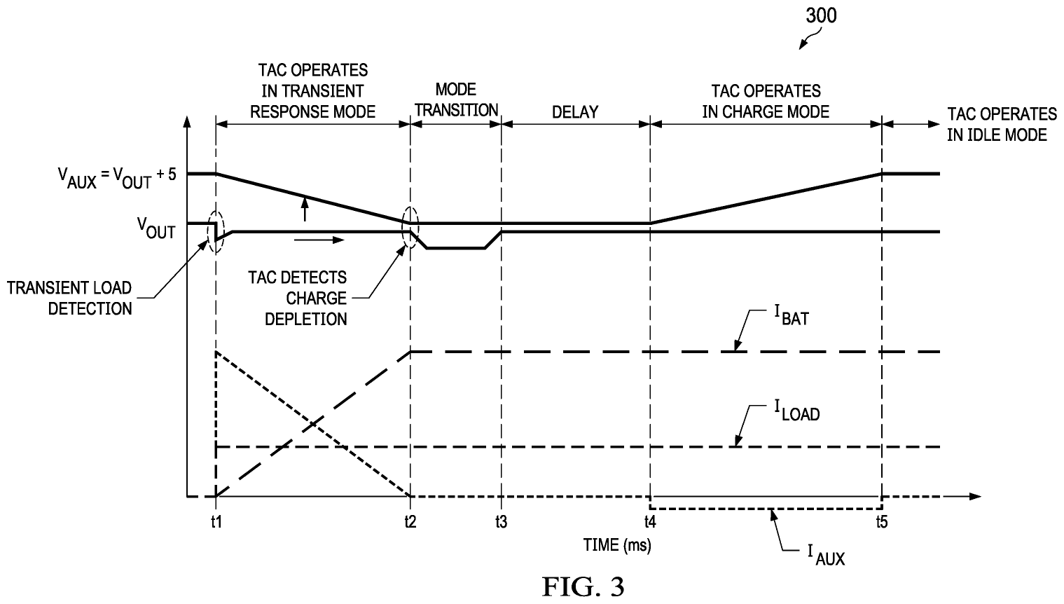

FIGS. 3-6 are graphs of system signals as a function of time in accordance with example embodiments. In graph 300 of FIG. 3, V_{AUX}, V_{OUT}, an auxiliary current (I_{AUX}), a battery current (I_{BAT}), and I_{LOAD} are represented as a function of time. At time t1 in graph 300, I_{LOAD} increases, resulting in a detectable drop in V_{OUT} (i.e., a transient load detection). Responsive to the transient load detection, I_{BAT} increases over time and a transient auxiliary converter (TAC), such as the transient auxiliary converter 180 in FIG. 1, or the transient auxiliary converter 180A in FIG. 2, operates in the transient response mode. In the transient response mode, I_{AUX} is provided from the TAC to the load, such that I_{AUX} decreases over time and V_{OUT} is maintained without drawing as much power from a power supply (e.g., the power supply 102 in FIG. 1) at the input of a power stage. At time t2, the charge stored by the TAC is depleted and I_{BAT} has settled. From time t2 to time t3, V_{OUT} decreases slightly once the TAC charge has been depleted, but eventually returns to its target value at t3 based on the operations of a power stage (e.g., the power stage 160 in FIG. 1, or the power stage 160A in FIG. 2) coupled to the load. At time t3, a mode transition is initiated to transition the TAC from the transient response mode to the charge mode. After a delay, the TAC begins operating in the charge mode at time t4 while the load is in a steady-state load condition. In the charge mode, charge is built up or stored by the TAC from the charge available at the power stage output. Also, I_{AUX} is slightly negative as charge is being drawn from the power stage output to charge C_{AUX}. At time t5, the charge built up by the TAC reaches a target threshold or target auxiliary voltage, and the TAC transitions from the charge mode to the idle mode to maintain the charge until a subsequent load transient occurs. As needed, another charge mode is used if V_{AUX} drops below a threshold before the subsequent load transient occurs.

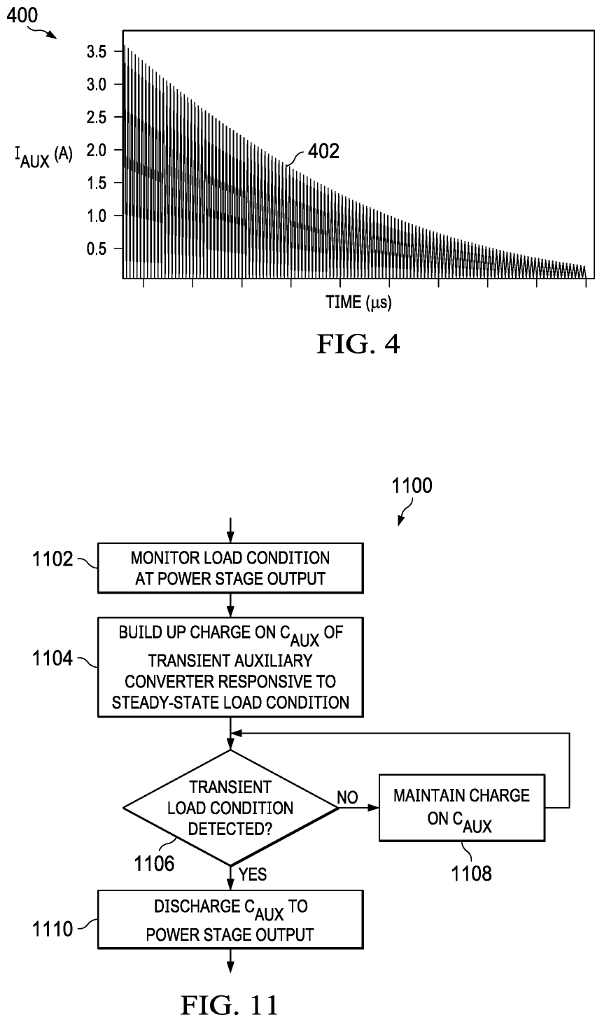

In graph 400 of FIG. 4, I_{AUX} is represented as a function of time. In the example of FIG. 4, I_{AUX} has the form of an exponential decay to complement a target rise pattern (e.g., 1−e^{-t/τ}, where t is time and τ is a time constant) in a critically damped system. In some example embodiments, the transient response mode of a TAC is a constant on-time (COT) critical mode with I_{AUX} having an exponential decay with the form e^{-t/kTon}, where t is time, k is a number of Ton pulses (fixed or programmable) to decay the TAC's surplus voltage, and Ton is the switch on-time for switches of the TAC during a transient response mode.

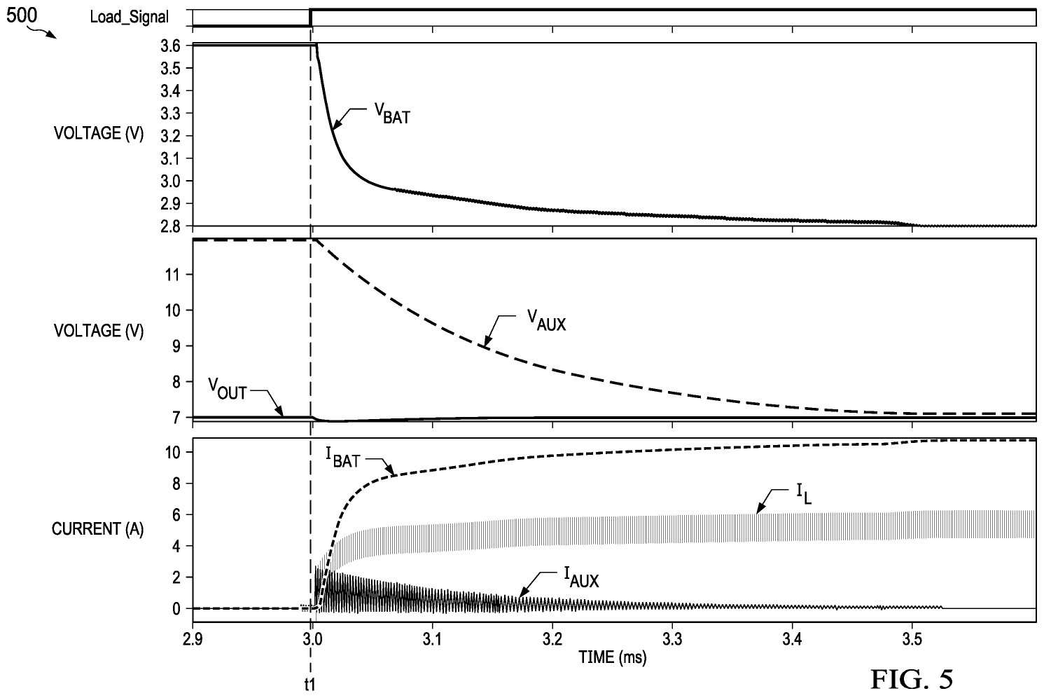

In graph 500 of FIG. 5, a load signal, V_{BAT}, V_{AUX}, V_{OUT}, I_{BAT}, an inductor current (I_{L}), and I_{AUX} are represented as a function of time. At time t1 in graph 400, a load signal is asserted responsive to a transient load condition (a load demand increase) being detected. In response to the transient load condition, V_{OUT} temporarily dips, V_{BAT} decreases, I_{BAT} increases, and I_{L} (the current of the inductor 162 of the power stage 160, or the current of L₁ or L₂ of the two-phase boost converter 160A in FIG. 2) increases and is maintained within a range of current values. Also, V_{AUX} and I_{AUX} related to a TAC decrease after time t1. Due to the TAC supplying current from previously stored charge on C_{AUX} to the power stage output responsive to the load transient condition, the amount of surge in I_{BAT} responsive to the transient load condition is decreased.

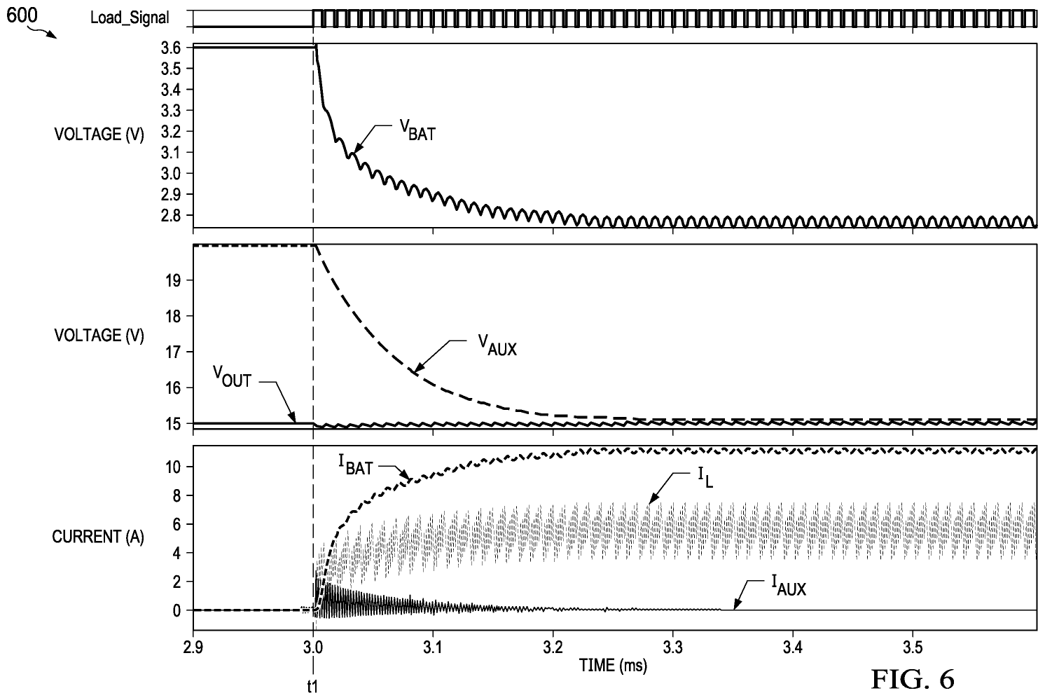

In graph 600 of FIG. 6, a load signal, V_{BAT}, V_{AUX}, V_{OUT}, I_{BAT}, I_{L}, and I_{AUX} are represented as a function of time. At time t1 in graph 600, a load signal is asserted responsive to a transient load condition (a load demand increase) being detected. As shown, the load signal in FIG. 6 has a duty cycle (e.g., 80%), which means the load demand cycles between an on-time and an off-time. In response to the ongoing transient load condition, V_{OUT} has ripple, V_{BAT} decreases and has ripple, I_{BAT} increases and has ripple, and I_{L} increases and has ripple resulting in a range of values for I_{L}. Also, V_{AUX} and I_{AUX} related to a TAC decrease after time t1. Due to the TAC supplying current from previously stored charge on C_{AUX} to the power stage output responsive to the load transient condition, the amount of surge in I_{BAT} responsive to the transient load condition is decreased.

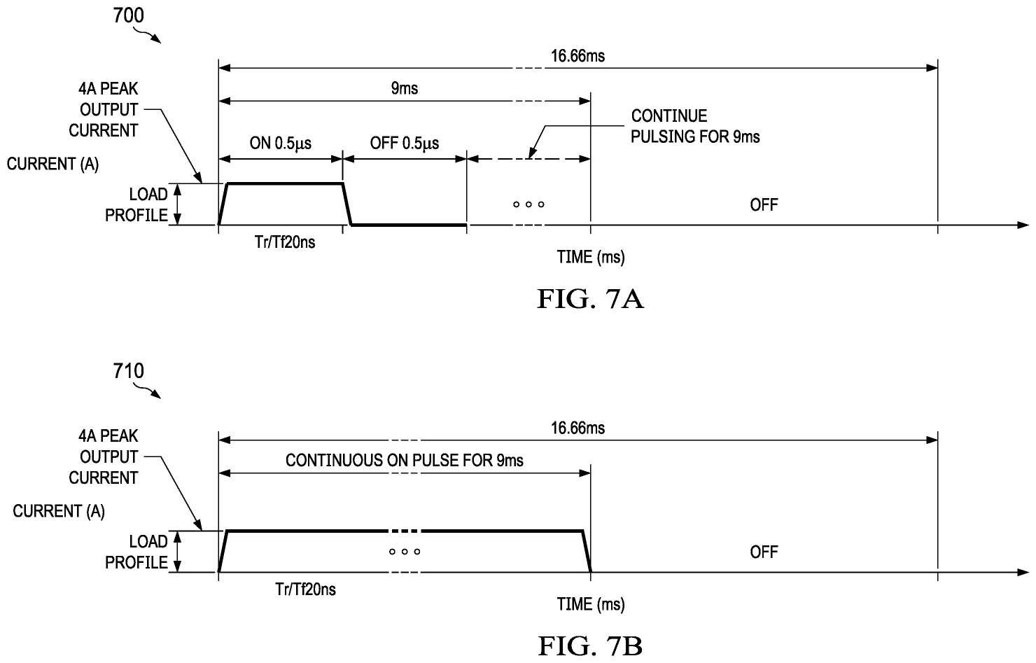

FIGS. 7A-7C are graphs 700, 710, and 720 of load profiles as a function of time in accordance with example embodiments. In graph 700 of FIG. 7A, the load profile has a duty cycle of 50% for a time interval with a peak current of 4 A. After the time interval, the load turns off. In graph 710 of FIG. 7B, the load profile stays on for a time interval with a peak current of 4 A. After the time interval, the load turns off. In graph 720 of FIG. 7C, the load profile has a triangle wave form or a sine wave form during spaced time intervals. After the spaced time intervals, the load turns off for a time, then the pattern is repeated. When a TAC is used with certain load profiles such as the load profile in graph 720, the TAC may perform V_{OUT} ripple cancellation to help smooth V_{OUT}.

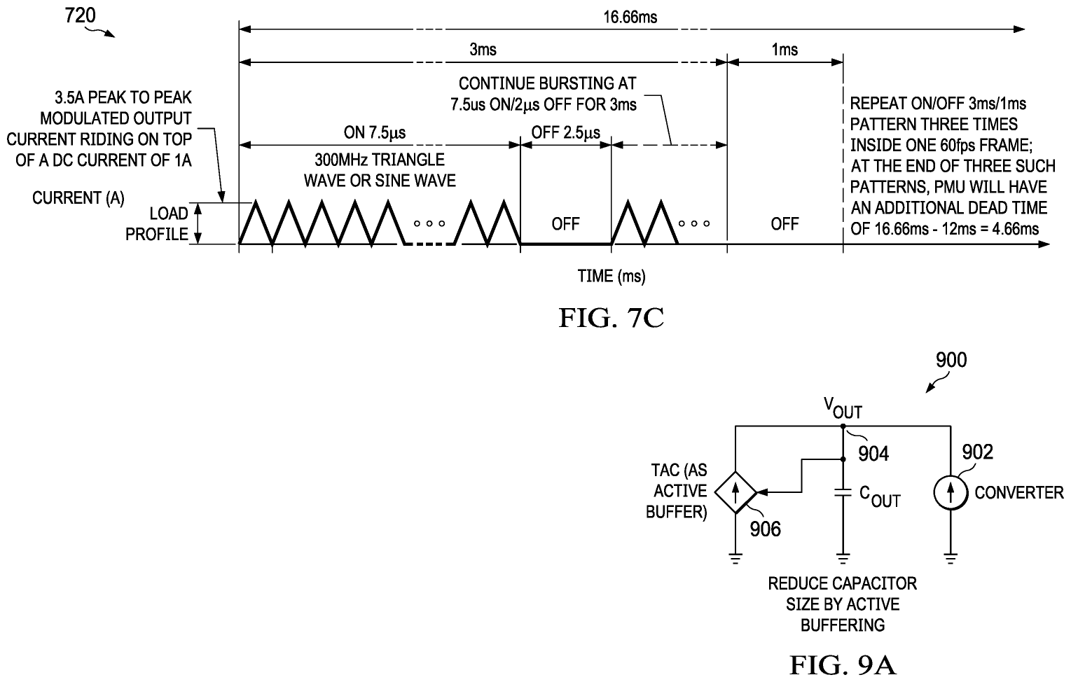

FIG. 8 is a graph 800 of system signals as a function of time in accordance with an example embodiment. In graph 800 of FIG. 8, a load signal, V_{BAT}, V_{OUT}, I_{BAT}, and I_{L} are represented as a function of time. At time t1 in graph 800, a load signal is asserted responsive to a transient load condition (a load increase) being detected. As shown, the load signal in FIG. 8 has a duty cycle (e.g., 80%). In response to the ongoing transient load condition, V_{OUT}, V_{BAT}, I_{BAT}, and I_{L} have ripple. A conventional approach to reduce the ripple is to use a larger output capacitor (C_{OUT}) at the power stage output. However, this increases the system cost. Another option is to perform V_{OUT} ripple cancellation using a TAC.

FIG. 9A is a diagram of an equivalent circuit 900 in accordance with an example embodiment. The equivalent circuit includes a current source 902 and a voltage-to-current converter 906 coupled to an output terminal 904. As shown, C_{OUT} is coupled between the output terminal 904 and ground. The voltage at the output terminal 904 is V_{OUT}, which is used to power a load (not shown). V_{OUT} also controls the voltage-to-current converter 906. In the equivalent circuit 900, the current source 902 is compared to the power stage 160 in FIG. 1, or the two-stage boost converter 160A in FIG. 2. Also, the voltage-to-current converter 906 is compared to the transient auxiliary converter 180 in FIG. 1, or the transient auxiliary converter 180A in FIG. 2. With a transient auxiliary converter coupled to the output terminal 904 and operating as an active buffer, the size of C_{OUT} can be reduced.

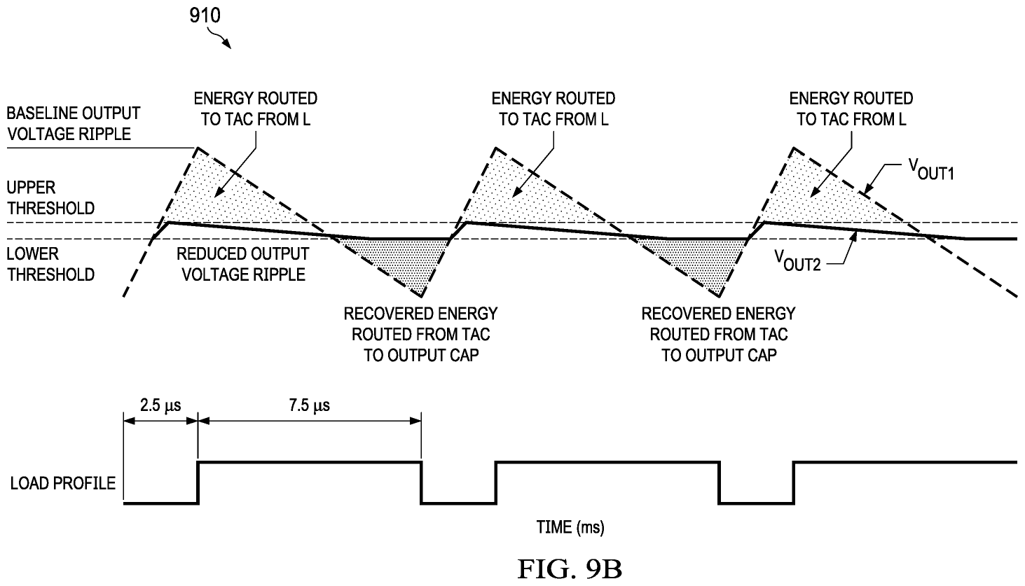

FIGS. 9B and 10 are graphs 910 and 1000 of system signals showing output voltage ripple cancellation using a transient auxiliary converter (e.g., the transient auxiliary converter 180 in FIG. 1, or the transient auxiliary converter 180A in FIG. 2) in accordance with an example embodiment. In graph 910 of FIG. 9B, a first output voltage (V_{OUT1}), a second output voltage (V_{OUT2}), and a load profile with a 75% duty cycle are represented as a function of time. An upper threshold and a lower threshold for V_{OUT2} is also shown. In graph 910, V_{OUT1} is a baseline output voltage ripple, and V_{OUT2} is a reduced output voltage ripple due to use of a TAC as described herein. With a TAC, when V_{OUT1} is greater than the upper threshold, energy is routed to the TAC from the inductor of a power stage. When V_{OUT1} is less than the lower threshold, recovered energy is routed from the TAC to the output capacitor (C_{OUT}) coupled to the power stage output. The result of active buffering using a TAC is that instead of a baseline output voltage ripple (e.g., V_{OUT1}), a reduced output voltage ripple (e.g., V_{OUT2}) due to active buffering or output voltage ripple cancellation is at the power stage output.

In the graph 1000 of FIG. 10, V_{AUX}, V_{OUT}, I_{BAT}, I_{L}, and I_{AUX} are represented as a function of time. As shown, when V_{OUT} decreases (e.g., due to a load demand increase), V_{AUX} decreases as well due to a TAC providing current to the power stage output responsive to the load demand increase. When V_{OUT} increases (e.g., due to a steady-state load or no load and operations of a power stage), V_{AUX} increases due to a TAC building up charge on C_{AUX} during the steady-state load condition or no load condition. Also, I_{AUX} oscillates at a switching frequency of the TAC. To keep L_{AUX} small, the switching frequency of the TAC switches may be higher than the switching frequency of the power stage. When a TAC discharges energy to a power stage output, the magnitude of oscillations of I_{AUX} are slowly reduced until V_{OUT} increases again and the pattern repeats. As shown, I_{L} increases when V_{OUT} decreases (i.e., I_{L} increases when the load increases). Also, I_{L} decreases when V_{OUT} increases (i.e., I_{L} decreases when the load decreases). In other words, the pattern of I_{L} inversely follows the pattern of V_{OUT}.

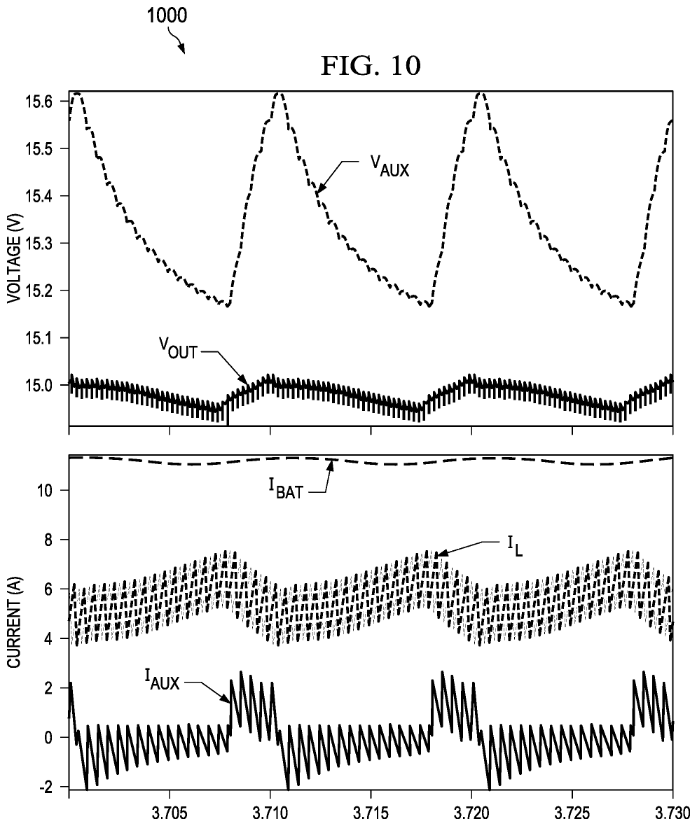

FIG. 11 is a flowchart of a transient auxiliary converter method 1100 in accordance with an example embodiment. The method 1100 is performed by a transient auxiliary converter (e.g., the transient auxiliary converter 180 in FIG. 1, or the transient auxiliary converter 180A in FIG. 2) and a related controller (e.g., the transient auxiliary converter controller 106 in FIG. 1, or the transient auxiliary converter controller 106A in FIG. 2). As shown, the method 1100 includes monitoring a load condition at a power stage output at block 1102. At 1104, charge on C_{AUX} of the transient auxiliary converter is built up responsive to a steady-stage load condition. If a transient load condition is not detected (determination block 1106), the charge on C_{AUX} is maintained at block 1108, and the method 1100 returns to determination block 1106. In some example embodiments, maintaining the charge on C_{AUX} involves alternating between a charge mode and an idle mode as needed responsive to a sense signal (e.g., V_{AUX}) or timing reference. If a transient load condition is detected (determination block 1106), C_{AUX} is discharged to the power stage output at block 1110. As another option, the transient auxiliary converter performs active buffering or V_{OUT} ripple cancellation for loads with a duty cycle.

In some example embodiments, a method is performed by a transient auxiliary converter (e.g., the transient auxiliary converter 180 in FIG. 1, or the transient auxiliary converter 180A in FIG. 2) coupled to a power stage output (e.g., the power stage output 172 in FIGS. 1 and 2). The method includes: monitoring a load condition at the power stage output; responsive to a steady-state load condition, storing charge from the power stage output to a capacitor of the transient auxiliary converter; and responsive to a transient load condition, releasing the stored charge on the capacitor to the power stage output. In some example embodiments, the method includes selectively adding charge to the capacitor during the steady-state load condition responsive to a sense signal that indicates a change on the capacitor. In some example embodiments, the method includes adding charge to the capacitor during the steady-state load condition responsive to a timing reference. In some example embodiments, the method includes performing active buffering at the power stage output to cancel output voltage ripple.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

As used herein, the terms “terminal,” “electrode,” “node,” “interconnection,” “pin,” “contact,” and “connection” are used interchangeably. Unless specifically stated to the contrary, these terms are generally used to mean an interconnection between or a terminus of a device element, a circuit element, an integrated circuit, a device or other electronics or semiconductor component.

The example embodiments above may utilize switches in the form of n-channel field-effect transistors (“NFETs”) or p-channel field-effect transistors (“PFETs”). Other example embodiments may utilize NPN bipolar junction transistors (BJTs), PNP BJTs, or any other type of transistor. Hence, when referring to a current electrode, such electrode may be an emitter, collector, source or drain. Also, the control electrode may be a base or a gate.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in this description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described embodiments, and other embodiments are possible, within the scope of the claims.

What is claimed is:

1. A transient auxiliary converter, comprising:
a transient auxiliary converter terminal;
an inductor having a first side and a second side, the first side of the inductor coupled to the transient auxiliary converter terminal;
a capacitor having a first electrode and a second electrode, the second electrode of the capacitor being coupled to ground;
a first switch between the second side of the inductor and the first electrode of the capacitor; and
a second switch between the second side of the inductor and ground, wherein the first switch and the second switch are operated in accordance with a charge mode and a transient response mode for the transient auxiliary converter, the charge mode builds up charge on the capacitor from charge at the transient auxiliary converter terminal, and the transient response mode releases charge on the capacitor to the transient auxiliary converter terminal.

2. The transient auxiliary converter of claim 1, further comprising a transient auxiliary converter controller having a transient auxiliary converter controller input and a transient auxiliary converter controller output, the transient auxiliary converter controller input configured to receive a load signal indicating a load condition, the transient auxiliary converter controller configured to:
select the charge mode responsive to the load signal indicating a steady-state load condition;
select the transient response mode responsive to the load signal indicating a transient-state load condition; and
provide a control signal at the transient auxiliary converter controller output responsive to the selected mode.

3. The transient auxiliary converter of claim 2, wherein the transient auxiliary converter controller input is a first transient auxiliary converter controller input, the transient auxiliary converter controller includes a second transient auxiliary converter controller input configured to receive a sense signal indicating a charge on the capacitor, and the transient auxiliary converter controller is configured to:
select the charge mode responsive to the load signal indicating a steady-state load condition and the sense signal being less than a threshold;
select an idle mode responsive to the load signal indicating a steady-state load condition and the sense signal being equal to or greater than the threshold;
select the transient response mode responsive to the load signal indicating a transient load condition; and
provide a control signal at the transient auxiliary converter controller output responsive to the selected mode.

4. The transient auxiliary converter of claim 3, wherein the threshold is a first threshold, and the transient auxiliary converter controller is configured to transition from the idle mode to the charge mode responsive to the load signal indicating a steady-state load condition and the sense signal being less than a second threshold.

5. The transient auxiliary converter of claim 2, wherein the transient auxiliary converter controller input is configured to:
obtain a time reference;
select the charge mode responsive to the load signal indicating a steady-state load condition and the time reference being less than a threshold;
select an idle mode responsive to the load signal indicating a steady-state load condition and the time reference being equal to or greater than the threshold;
select the transient response mode responsive to the load signal indicating a transient load condition; and
provide a control signal at the transient auxiliary converter controller output responsive to the selected mode.

6. The transient auxiliary converter of claim 5, the threshold is a first threshold, and the transient auxiliary converter controller is configured to transition from the idle mode to the charge mode responsive to the load signal indicating a steady-state load condition and the time reference being greater than a second threshold.

7. The transient auxiliary converter of claim 2, further comprising a driver circuit coupled to or included with the transient auxiliary converter controller, the driver circuit having a driver circuit input, a first driver circuit output and a second driver circuit output, the driver circuit input coupled to the transient auxiliary converter controller output, the first driver circuit output coupled to a control terminal of the first switch, and the second driver circuit output coupled to a control terminal of the second switch.

8. The transient auxiliary converter of claim 2, wherein the transient auxiliary converter controller is configured to operate the first switch and the second switch in the charge mode to build up charge on the capacitor from charge at the transient auxiliary converter terminal responsive to the load signal indicating a steady-state load condition until the sense signal indicates a target auxiliary voltage level is reached, the target auxiliary voltage level equal to a target output voltage plus a surplus voltage.

9. The transient auxiliary converter of claim 2, wherein the surplus voltage is approximately 5 volts.

10. The transient auxiliary converter of claim 2, wherein the transient auxiliary converter controller is configured to operate the first switch and the second switch to perform output voltage ripple cancellation.

11. A system, comprising:
a power stage having a power stage input, a power stage output and switches, the power stage input configured to receive an input voltage, and the power stage configured to provide an output voltage at the power stage output responsive to the input voltage and operation of the switches;
a power stage controller coupled to control terminals of the switches and configured to provide control signals to the control terminals to maintain the output voltage at a target output voltage; and
a transient auxiliary converter having a transient auxiliary converter terminal coupled to the power stage output, wherein the transient auxiliary converter is configured to:
store charge from the power stage output during a steady-state load condition; and
release the stored charge to the power stage output responsive a transient load condition after the steady-state load condition.

12. The system of claim 11, wherein the transient auxiliary converter includes:
an inductor having a first side and a second side, the first side of the inductor coupled to the transient auxiliary converter terminal;
a capacitor having a first electrode and a second electrode, the second electrode of the capacitor being coupled to ground;
a first switch between the second side of the inductor and the first electrode of the capacitor; and
a second switch between the second side of the inductor and ground.

13. The system of claim 12, further comprising a transient auxiliary converter controller configured to control the first switch and the second switch to build up the charge on the capacitor during the steady-state load condition up to a target auxiliary voltage, the target auxiliary voltage equal to a target output voltage plus a surplus voltage.

14. The system of claim 12, further comprising a transient auxiliary converter controller configured to retain voltage on the capacitor responsive to detecting that the charge on the capacitor reaches a threshold.

15. The system of claim 12, further comprising a transient auxiliary converter controller configured to alternate between a charge mode and an idle mode during the steady-state load condition responsive to a sense signal that indicates a voltage on the capacitor.

16. The system of claim 12, further comprising a transient auxiliary converter controller configured to operate the first switch and the second switch to perform output voltage ripple cancellation at the power stage output.

17. The system of claim 16, wherein the transient auxiliary converter controller and the power stage controller are part on a single integrated circuit.

18. A method performed by a transient auxiliary converter coupled to a power stage output, the method comprising:
monitoring a load condition at the power stage output;
responsive to a steady-state load condition, storing charge from the power stage output to a capacitor of the transient auxiliary converter; and
responsive to a transient load condition, releasing the stored charge on the capacitor to the power stage output.

19. The method of claim 18, further comprising selectively adding charge to the capacitor during the steady-state load condition responsive to a sense signal that indicates a change on the capacitor.

20. The method of claim 18, further comprising performing active buffering at the power stage output to cancel output voltage ripple.
